(19) United States
(12) Patent Application Publication
(10) Pub. No.: US 2005/0043067 A1
(43) Pub. Date: Feb. 24, 2005

(54) Voice recognition in a vehicle radio system

(76) Inventors: Thomas W. Odell, Whitby (CA); Axel Nix, Birmingham, MI (US); Timothy J. Grost, Clarkston, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/646,559

(22) Filed: Aug. 21, 2003

(51) Int. Cl. H04Q 7/20

(52) U.S. Cl. 455/569.2

(57) ABSTRACT

A vehicle radio system and a method of operating the vehicle radio system are provided in accordance with the present invention. The vehicle radio system includes a radio receiver that is configured to receive a radio signal from a broadcast station, a microphone that is configured to receive an audible from an operator of the vehicle radio system and generate an audible signal from said audible and a tuning module configured to receive the radio signal from the radio receiver and the audible signal from the microphone. The tuning module includes a storage module configured to store a first phoneme string and a first channel number associated with the first phoneme string, a voice recognition engine configured to compare a phoneme in the audible signal with the first phoneme string stored in the storage module and a tuner configured to tune the radio receiver to the first channel number when the voice recognition engine identifies the phoneme as the first phoneme string.

### TECHNICAL FIELD

The present invention generally relates to voice recognition, and more particularly relates to voice recognition in a vehicle radio system.

### BACKGROUND

Voice-based user interfaces for audio, visual or audiovisual radio systems are becoming more and more popular, particularly in environments where the user's hands are otherwise occupied with activities associated with controlling a vehicle (e.g., an automobile). Such voice-based user interfaces are currently used to control numerous parameters of radio systems, including volume, fade, balance and channel selection. However, radio systems with voice-based user interfaces are generally limited to a fixed command set such as “volume up”, “radio 105.1 FM”, or “radio 22 XM,” and in the latter case, the frequency or channel number has to fall within a range of predetermined numeric values. Even though such fixed command sets provide adequate frequency/channel control in AM/FM radio systems, their use is limited in digital radio systems, such as XM or Digital Audio Broadcast (DAB).

Digital audio or digital television (i.e., digital radio systems) services offer a large number of channels, which makes it difficult for a user to remember a particular channel number. Furthermore, these numerous radio and television stations frequently promote the station name rather than a frequency or channel number as part of their branding strategy. Therefore, a user can be more familiar with a station name (e.g., CNN, MSNBC, WTBS, ESPN, ABC, NBC, FOX and CBS) rather than the frequency or channel number.

Radio system displays accommodate the importance of station names and solely produce these station identification names on the display or produce these station identification names in combination with the channel number. This ability to display the station names is possible because the name associated with a channel or frequency is generally encoded in the data stream received from the digital radio service. Accordingly, the most intuitive voice command to change a radio channel would hence use a format such as “radio channel <channel name>”. However, voice-based radio systems with a fixed command set are incapable of providing such an intuitive command base since the channel names generally change after original assembly of the radio system.

Broadcast stations currently broadcast audio signals in digital or analog formats, and in some cases broadcast data, which is also known as datacasting (e.g., satellite digital audio radio services, terrestrial digital audio broadcast, FM RDS, and digital television and the like. Datacasting schemes are currently used for a variety of messages covering a wide range of services that include, but is not limited to, additional audio channels, GPS correction signals, paging, MUSAC, program related data, advertisements, weather and traffic information. While datacasting schemes also datacast station identifications as text messages for display on a radio or television screen, voice recognition systems or similar techniques are not available that fully utilize or format the datacast station identifications for voice-based user control of channel or station selection in radio systems.

In view of the foregoing, it is desirable to create a phonetic transcription to represent information such as channel or station information for datacast to radio system receivers that employ voice recognition. It is further desirable that mechanisms be employed to optimize the performance of the overall radio system by providing the capability to modify the phonetic representation of the datacast in the event of a change in name or channel such that the voice recognition process is optimized for the greatest number of voices, improved accuracy, and to potentially enable multiple phonetic representations for different accents and languages. Accordingly, it is desirable to provide a dynamic voice recognition capability for names of radio channel. In addition, it is desirable to optimize the accuracy of such channel-name voice recognition. Furthermore, other desirable features and characteristics of the present invention will become apparent from the subsequent detailed description of the invention and the appended claims, taken in conjunction with the accompanying drawings and this background of the invention.

### BRIEF SUMMARY

A vehicle radio system is provided in accordance with the present invention. The vehicle radio system includes a radio receiver that is configured to receive a radio signal from a broadcast station, a microphone that is configured to receive an audible from an operator of the vehicle radio system and generate an audible signal from said audible and a tuning module configured to receive the radio signal from the radio receiver and the audible signal from the microphone. The tuning module includes a storage module configured to store a first phoneme string and a first channel number associated with the first phoneme string, a voice recognition engine configured to compare a phoneme in the audible signal with the first phoneme string stored in the storage module and a tuner configured to tune the radio receiver to the first channel number when the voice recognition engine identifies the phoneme as the first phoneme string.

A method of operating the vehicle system is also provided in accordance with the present invention. The method includes the steps of receiving a radio signal from a broadcast station, receiving an audible from an operator of the vehicle radio system and generating an audible signal from audible. In addition the method includes the steps of storing a first phoneme string and a first channel number associated with the first phoneme string, comparing a phoneme in the audible signal with the first phoneme string and tuning to the first channel number when the comparing the phoneme in the audible with the first phoneme string identifies the phoneme as the first phoneme string.

### BRIEF DESCRIPTION OF THE DRAWINGS

The present invention will hereinafter be described in conjunction with the following drawing figures, wherein like numerals denote like elements, and:

FIG. 1 is a schematic block diagram illustrating a vehicle radio system in accordance with an exemplary embodiment of the present invention;

FIG. 2 is a flow chart illustrating a method of operating the vehicle radio system of FIG. 1 in accordance with a exemplary embodiment of the invention; and

FIG. 3 is a flow chart illustrating a method of operating a broadcasting system in accordance with an exemplary embodiment of the present invention.

### DETAILED DESCRIPTION

The following detailed description of the invention is merely exemplary in nature and is not intended to limit the invention or the application and uses of the invention. Furthermore, there is no intention to be bound by any expressed or implied theory presented in the preceding background or the following detailed description.

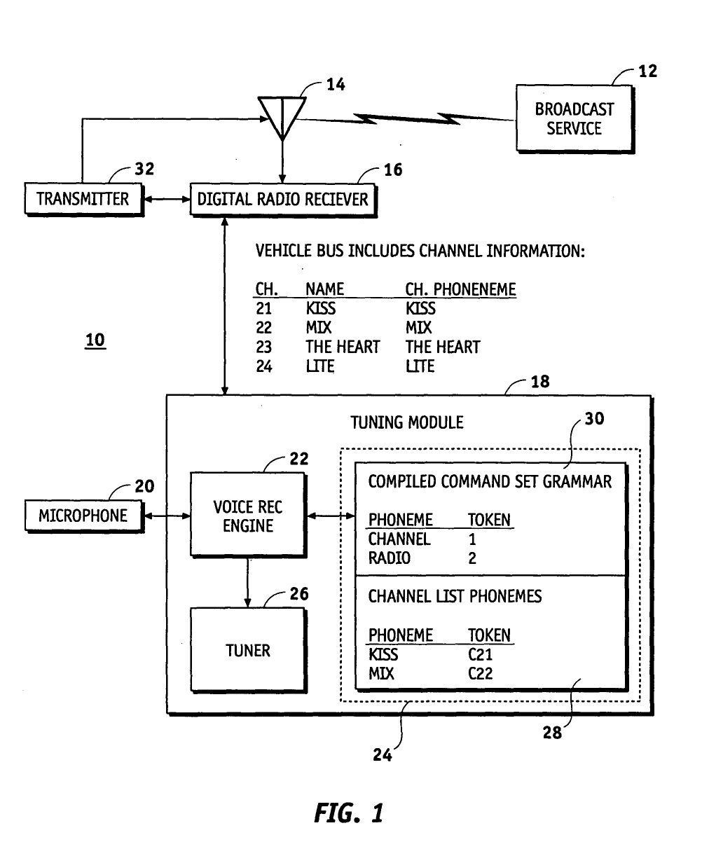

FIG. 1 is a simplified block diagram of a vehicle radio system 10 in accordance with an exemplary embodiment of the invention. The radio system 10 is configured to receive signals with an antenna 14 of a radio receiver 16. The signals are preferably transmitted by a digital broadcast service 12, which can be a satellite broadcast service (e.g., XM satellite radio, satellite radio or television system) or a terrestrial broadcast service (e.g., Digital Audio Broadcast (DAB)). While the radio receiver 16 is described in the context of a digital radio receiver, the present invention is applicable to other non-digital systems if appropriate coders/decoders are provided for efficient operation of the voice recognition engine with a particular data type (e.g., FM RDS (Radio Data System)). In addition, while the radio receiver described in this detailed description is an audio system, the present invention is applicable to a visual system (e.g., television) or combination audio/visual system. For example, the present invention is applicable to change a television channel or program (i.e., “change channel to CNN”, or “change program to 60 minutes”). Furthermore, while the description refers to an automobile, any number of land, sea, air or space vehicles can have the vehicle radio system of the present invention and the methods of the present invention can be implemented in any number of land, sea, air or space vehicles.

The digital radio receiver 16 includes components and subsystems (not shown) of a conventional nature that receives the signals transmitted by the broadcast service 12. The digital radio receiver 16 detects and decodes the signals to produce any number of formats, such as data, audio, visual, or audiovisual formats. The digital radio receiver 16 also preferably includes amplifiers, speakers or displays to present the transmitted signal in a format the user of the digital radio receiver 16 can perceive. The transmitted signal from the broadcast station 12 preferably includes station and channel identifiers and other information relating to the type of information broadcast by the service. For example, the information can identify the channel as popular music, classical music, or the like.

As previously described in this detailed description, the signal received by the antenna 14 is provided to the digital radio receiver 16 that decodes the digital transmission and produces audio and/or visual information to the user of the vehicle radio system 10. A tuning module 18 is coupled to the digital radio receiver 16 and coupled to a microphone 20 through which the user of the vehicle radio system 10 can communicate tuning information as well as other functional commands (e.g., volume, fade, balance, and the like).

The tuning module 18 has a voice recognition engine 22 that receives signals from the microphone 20. The voice recognition engine 22 may be integral to the digital radio receiver 16 or it may be a separate unit, and the voice recognition engine 22 can identify functional voice commands of the vehicle radio system 10 other than tuning commands. For example, the voice recognition engine 22 can be used to identify a volume command, fade command, balance command or other functional commands of the vehicle radio system 10.

The tuning module 18 also has a storage module 24 coupled to the voice recognition engine 22 that is configured to at least store information relating to the programming information for channels received by the digital radio receiver 16. The voice recognition engine 22 is additionally coupled to a tuner 26 that is operable to tune the digital radio receiver 16 to a particular channel.

In an exemplary embodiment, the digital data stream transmitted by the broadcast service 12 includes strings of phonemes describing channel names or programming formats (e.g., sports, news, talk, music, etc.). The vehicle radio system 10 stores the strings of phonemes with channel numbers associated with each of the phoneme strings in the storage module 24. The phonemes can be stored in a table and the radio system 10 can use the table as an input to the voice recognition engine 22. The table of phonemes stored in the radio is dynamically generated based on the currently available channels. Since channel names are changed infrequently, the strings of phonemes transmitted by the digital radio service 12 can be ‘manually’ optimized with linguistic techniques known to those of ordinary skill to reflect the typical pronunciation(s) of the channel name.

The voice recognition engine 22 is configured to compare the phonemes in an audio command issued by the user with the phoneme strings stored in the table of the storage module 24. If a match between the user command and the table stored phoneme is found, the tuner 26 tunes the radio system 10 to the channel corresponding to the audible command. For example, if a user commands “radio channel CNN,” the voice recognition engine 22 identifies the words “radio channel” based on a fixed command set stored in a fixed command table 30 of the storage module 24. The variable part “CNN” is also compared with phonemes in the channel table 28 of available channels. The voice recognition engine 22 is configured to match and adjust the tuner 26 to the channel number corresponding with the “CNN” string of phonemes in the table such that the corresponding signal transmitted by the broadcast service 12 is received by the radio system 10.

In accordance with an exemplary embodiment of the present invention, the broadcast service 12 transmits channel names in a phonetic spelling rather than phonemes. This allows the voice recognition engine 22 in the vehicle radio system 10 to independently compile a string of phonemes. The availability of the phonetic spelling improves voice recognition accuracy when compared to previously availability limited to the readable channel name. When compared to transmitting phonemes, the phonetic spelling is more universal, works with different voice recognition engines, and reduces the amount of data transmitted to the vehicle radio system 10. For example, the channel names “the 90s” or “ESPN News” would be difficult for an on-board voice recognition engine to compile into a string of phonemes suitable for recognizing the typical pronunciation of the channel name. However, if the phonetic spelling of “the nineties” or “E S P N news” is provided to an on-board voice recognition engine, an improved string of phonemes can be compiled to improve the recognition rate.

Common to both embodiments is that the radio service 12 preferably transmits channel name information in a format specifically designed for use in voice recognition engines in addition to the channel name intended to be displayed on the radio display. For applications involving two-way radio transmission, as will be subsequently described in this detailed description, a transmitter 32 can be provided to allow the user of the radio receiver 16 to communicate with a broadcaster 12 or other provider of information.

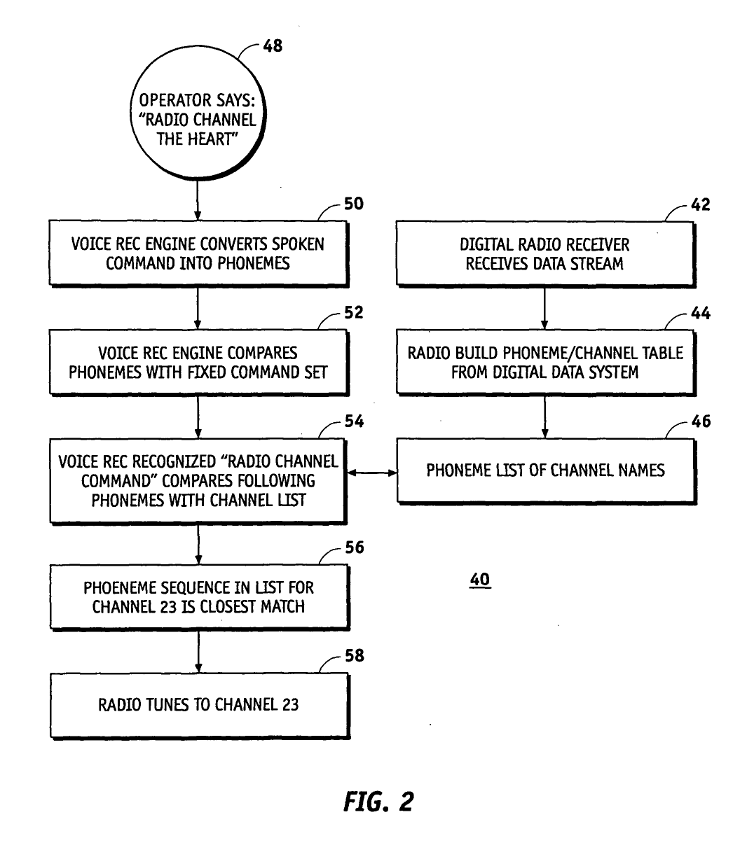

Referring to FIG. 2 a flow chart 40 is provided that illustrates the operation of the vehicle radio system 10 of FIG. 1 in accordance with an exemplary embodiment of the present invention. The digital radio receiver 16 receives a data stream from the broadcast service 42. The radio builds a phoneme/channel table from the digital data stream 44, which is then stored in a portion of memory module 46. An audio command is received by the microphone 48. For example, “Radio channel the heart” is received by the microphone. The voice recognition engine converts the command into phonemes 50, compares the phonemes with the fixed command set 52 that is stored in the portion of the memory module and recognizes “radio channel” as a command. The voice recognition engine subsequently searches the channel list phonemes for the closest match to audio phoneme (e.g., “the heart”) 54. Once the closest match is determined from the search, the tuner is directed to the associated channel 56 (e.g., if the search determines the closest match is channel “23,” the channel is tune to channel “channel 23.” As previously described in this detailed description, if a phoneme data base is not made available by broadcast service, a phonetic data base may be developed to serve a similar purpose. In addition, different pronunciations or forms of a channel name can be provided to accommodate different dialects and the broadcast service 12 can transmit more than one string of phonemes or phonetic spellings for the same channel number.

The voice recognition interface also can be used for tasks other than channel tuning or tasks in addition to channel tuning. For example, a song title or an artist name might also be transmitted phonetically or by phonemes, thereby allowing a user to command the radio to periodically or continuously search for a particular song or artist and to tune to a particular channel whenever his/her favorite song/artist is played.

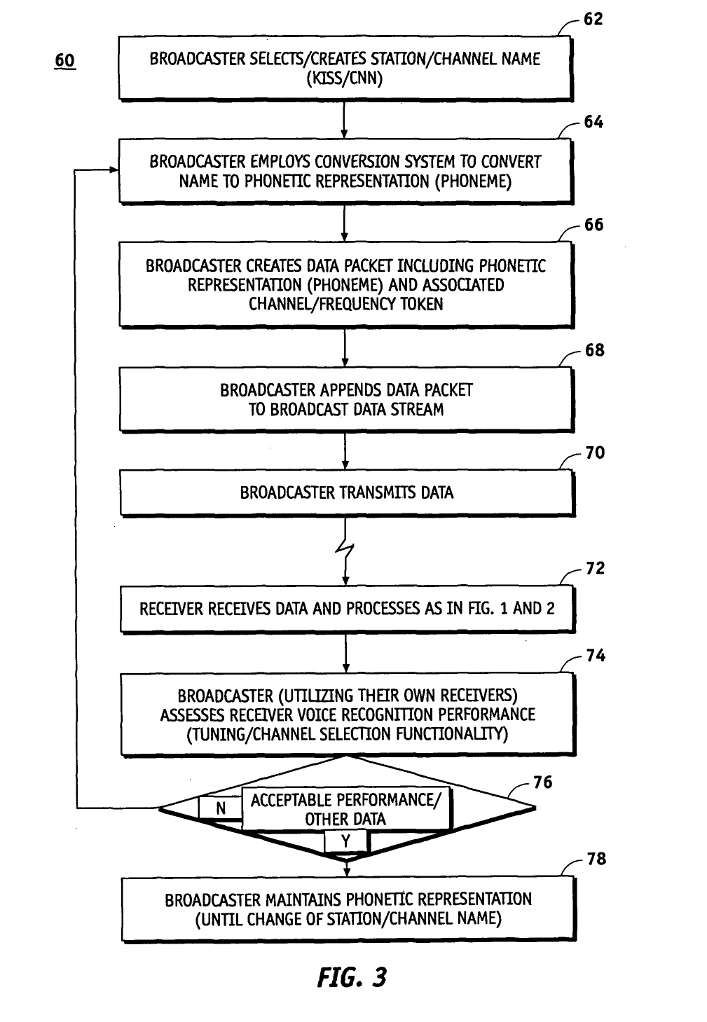

FIG. 3 is a flow chart 60 describing the operation of a broadcasting system that supports the functionality of the vehicle radio system of FIG. 1. The broadcast system selects or creates a station or channel name 62. The broadcast system then employs a conversion system, which is well known to those of ordinary skill in the art, to convert the selected name into a phonetic representation or a group of phonemes that represent the selected name 64. As previously noted, a broadcaster may select more than one representation for a name to allow for variations in speech or language of different users. For example a user in Mexico may use a different word to describe a particular type of programming than would a user in the United States of America. Also, as previously noted in this detailed description, if the system is used for program selection and receiver tuning, the broad system can be configured to provide a number of phonetic representations of programming words or music titles. And in the case of an e-commerce use, a number of words would be phonetically encoded to conduct such commerce.

Continuing with FIG. 3, a data packet is created 66 that includes the phonetic or phonemic representations of the data to be transmitted and also includes the associated channel or frequency information. The data packet is then included in the normal broadcast data stream 68. As an alternative, the data packet could be separately broadcast. For example, the data packet could be separately broadcast on a sideband of the transmitted signal, on a control channel, or as a sub-band signal or the like. The data is then transmitted 70 using a selected broadcasting technique.

The digital radio receiver 16 receives the transmitted signal containing the phonetic data 72 and processes the data as set forth in the previous descriptions with reference to FIG. 1 and FIG. 2. The broadcast system, which can utilize its own receiver, can assess the quality of the phonetic or phonemic data 74 in terms of the performance of the receiver's voice recognition engine and the functionality of the tuning mechanism of the radio. If the performance is acceptable, the broadcast system maintains the current phonetic representation 78 until some event, such as a change in station name or station identifier, dictates a change. If the performance of the voice recognition engine is not acceptable, that information is fed back to the conversion system 64 for further refinement and the process repeats. If the system is to be used in another context, such as e-commerce, the transmitter associated with the digital radio receiver of the vehicle radio system can be used to conduct two-way communication of other data to the broadcast system, in which case the feedback would be directed to the appropriate receiver of the e-commerce broadcaster.

While the invention has been disclosed in the context of a digital radio or television receiver and transmitter, the voice recognition function has other applications. For example, the transmitting station can be a merchant engaged in electronic commerce. In a two-way radio environment, dynamically built tables of strings of phonemes can be used to facilitate m-commerce functionality in a radio. Rather than limiting user interaction to fixed command sets allowing only predetermined “yes” and “no” answers an m-commerce application, downloaded phonemes or phonetic spellings can provide “smart” dialogs. For example, in an imaginary example of buying roses, the application might request the color of roses to be bought. The m-commerce provider would download the phonemes/phonetic spellings for “red”, “white” and “yellow” into the vehicle radio system to allow the user to answer the question in a natural way. The answer-choices would be transmitted to the vehicle specifically for each answer choice within an m-commerce dialog.

While exemplary embodiments have been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A vehicle radio system, comprising:
a radio receiver that is configured to receive a radio signal from a broadcast station;
a microphone that is configured to receive an audible from an operator of the vehicle radio system and generate an audible signal from said audible; and
a tuning module configured to receive said radio signal from said radio receiver and said audible signal from said microphone; said tuning module comprising:
a storage module configured to store a first phoneme string and a first channel number associated with said first phoneme string;
a voice recognition engine configured to compare a phoneme in said audible signal with said first phoneme string stored in said storage module; and
a tuner configured to tune said radio receiver to said first channel number when said voice recognition engine identifies said phoneme as said first phoneme string.

2. The vehicle radio system as set forth in claim 1, wherein:
said storage module is configured to store a second phoneme string and a second channel number associated with said second phoneme string;
said voice recognition engine is configured to compare said phoneme in said audible signal with said second phoneme string stored in said storage module; and
said tuner is configured to tune said radio receiver to said second channel number when said voice recognition engine identifies said phoneme as said second phoneme string.

3. The vehicle radio system as set forth in claim 2, wherein:
said storage module is configured to store a third phoneme string and a third channel number associated with said third phoneme string;
said voice recognition engine is configured to compare said phoneme in said audible signal with said third phoneme string stored in said storage module; and
said tuner is configured to tune said radio receiver to said third channel number when said voice recognition engine identifies said phoneme as said third phoneme string.

4. The vehicle radio system as set forth in claim 1, wherein:
said storage module is configured to store a second phoneme string and a first programming format associated with said second phoneme string;
said voice recognition engine is configured to compare said phoneme in said audible signal with said second phoneme string stored in said storage module; and
said tuner is configured to tune said radio receiver to a second channel number associated with said first programming format when said voice recognition engine identifies said phoneme as said second phoneme string.

5. The vehicle radio system as set forth in claim 4, wherein said first programming format is a sports programming format.

6. The vehicle radio system as set forth in claim 1, wherein said radio signal transmitted by said broadcast service is a digital radio signal.

7. The vehicle radio system as set forth in claim 1, wherein said broadcast service is a satellite broadcast service.

8. The vehicle radio system as set forth in claim 1, wherein:
said storage module is configured to store a second phoneme string and a first functional command associated with said second phoneme string; and
said voice recognition engine is configured to compare said phoneme in said audible signal with said second phoneme string stored in said storage module and request said first functional command when said voice recognition engine identifies said phoneme as said second phoneme string.

9. The vehicle radio system as set forth in claim 8, wherein said functional command is a volume command.

10. The vehicle radio system as set forth in claim 1, wherein said first phoneme string is a phonetic spelling of said first channel number.

11. A method of operating a vehicle radio system, comprising the steps of:
receiving a radio signal from a broadcast station; receiving an audible from an operator of the vehicle radio system;
generating an audible signal from said audible;
storing a first phoneme string and a first channel number associated with said first phoneme string;
comparing a phoneme in said audible signal with said first phoneme string; and
tuning to said first channel number when said comparing said phoneme in said audible with said first phoneme string identifies said phoneme as said first phoneme string.

12. The method as set forth in claim 11, further comprising the steps of:
said storage module is configured to store a second phoneme string and a second channel number associated with said second phoneme string;
comparing said phoneme in said audible signal with said second phoneme string; and
tuning said radio receiver to said second channel number when said comparing said phoneme in said audible with said second phoneme string identifies said phoneme as said second phoneme string.

13. The method as set forth in claim 12, further comprising the steps of:
said storage module is configured to store a third phoneme string and a third channel number associated with said third phoneme string;
comparing said phoneme in said audible signal with said third phoneme string; and
tuning said radio receiver to said third channel number when said comparing said phoneme in said audible with said third phoneme string identifies said phoneme as said third phoneme string.

14. The method system as set forth in claim 11, further comprising the steps of:
storing a second phoneme string and a first programming format associated with said second phoneme string;
comparing said phoneme in said audible signal with said second phoneme string; and
tuning said radio receiver to a second channel number associated with said first programming format when said comparing said phoneme in said audible signal with said second phoneme string identifies said phoneme as said second phoneme string.

15. The method as set forth in claim 14, wherein said first programming format is a sports programming format.

16. The method as set forth in claim 11, wherein said radio signal is a digital radio signal.

17. The method as set forth in claim 11, wherein said broadcast service is a satellite broadcast service.

18. The method as set forth in claim 11, further comprising the steps of:
storing a second phoneme string and a first functional command associated with said second phoneme string; and
comparing said phoneme in said audible signal with said second phoneme string; and
requesting said first functional command when said comparing said phoneme in said audible signal with said second phoneme string identifies said phoneme as said second phoneme string.

19. The method as set forth in claim 18, wherein said functional command is a volume command.

20. The method as set forth in claim 11, wherein said first phoneme string is a phonetic spelling of said first channel number.
